(19) United States
(12) Patent Application Publication
(10) Pub. No.: US 2023/0186121 A1
(43) Pub. Date: Jun. 15, 2023

(54) COMPUTER OPTIMIZATION OF TASK PERFORMANCE THROUGH DYNAMIC SENSING

(71) Applicant: International Business Machines Corporation, Armonk, NY (US)

(72) Inventors: Jenny S. Li, Franklinton, NC (US); Nirmit V. Desai, Yorktown Heights, NY (US); Dhiraj Joshi, Edison, NJ (US); Raghu Ramaswamy, Bangalore (IN); Satish Rajani, Dewas (IN)

(21) Appl. No.: 17/548,182

(22) Filed: Dec. 10, 2021

(51) Int. Cl. G06N 5/04; G06K 9/62; G06N 20/00

(52) U.S. Cl. CPC G06N 5/04; G06K 9/6259; G06N 20/00

(57) ABSTRACT

A method, computer program product, and system include a processor(s) that engages, based on a request for an inference, from a group of sensors of multiple modalities at a physical location, sensor(s) of a main modality to provide data to a pipeline to generate the inference. The pipeline includes one or more machine learning models which generate the inference for a downstream task. The processor(s) obtains raw data from the sensor(s) of the main modality and applies an outlier detector to the raw data. Based on determining that there is an outlier the processor(s) automatically engages sensor(s) of at least one different modality than the main modality from the group of sensors of multiple modalities and obtains new raw data from the sensor(s) of the at least one different modality. The processor(s) applies the one or more machine learning models to the new raw data to derive the inference.

### BACKGROUND

Physical environments that are being inspected can be dynamic, noisy, and/or unpredictable, so sensing can be sub-optimal sensing for certain modalities (e.g., taking pictures or sight at night). Noise in received data in various modalities can create sub-optimal performance of artificial intelligence (AI) tasks downstream. When data is not useable, the system is less efficient as energy consumption costs can also be high when modalities are on and thus, multiple sensors can consume a lot of energy, which poses efficiency issues. Thus, there are various situation when collected data by sensors cannot be utilized by downstream AI or other processes.

### SUMMARY

Shortcomings of the prior art are overcome, and additional advantages are provided through the provision of a method for dynamically utilizing sensors to make inferences for downstream tasks. The method includes, for instance: engaging, by one or more processors, based on a request for an inference, from the group of sensors of the multiple modalities at a physical location, at least one sensor of a main modality to provide data to a pipeline to generate the inference, wherein the pipeline comprises one or more machine learning models, and wherein the one or more machine learning models generate the inference for a downstream task; based on the engaging of the at least one sensor of the main modality, obtaining, by the one or more processors, raw data from the at least one sensor of the main modality; applying, by the one or more processors, an outlier detector to the raw data to determine if there is an outlier in the raw data; based on determining that there is an outlier in the raw data, automatically engaging, by the one or more processors, at least one sensor of at least one different modality than the main modality from the group of sensors of multiple modalities; based on the automatically engaging of the at least one sensor of the at least one different modality, obtaining, by the one or more processors, new raw data from the at least one sensor of the at least one different modality; and applying, by the one or more processors, the one or more machine learning models to the new raw data to derive the inference.

Shortcomings of the prior art are overcome, and additional advantages are provided through the provision of a computer program product for dynamically utilizing sensors to make inferences for downstream tasks. The computer program product comprises a storage medium readable by a one or more processors and storing instructions for execution by the one or more processors for performing a method. The method includes, for instance: engaging, by the one or more processors, based on a request for an inference, from the group of sensors of the multiple modalities at a physical location, at least one sensor of a main modality to provide data to a pipeline to generate the inference, wherein the pipeline comprises one or more machine learning models, and wherein the one or more machine learning models generate the inference for a downstream task; based on the engaging of the at least one sensor of the main modality, obtaining, by the one or more processors, raw data from the at least one sensor of the main modality; applying, by the one or more processors, an outlier detector to the raw data to determine if there is an outlier in the raw data; based on determining that there is an outlier in the raw data, automatically engaging, by the one or more processors, at least one sensor of at least one different modality than the main modality from the group of sensors of multiple modalities; based on the automatically engaging of the at least one sensor of the at least one different modality, obtaining, by the one or more processors, new raw data from the at least one sensor of the at least one different modality; and applying, by the one or more processors, the one or more machine learning models to the new raw data to derive the inference.

Shortcomings of the prior art are overcome, and additional advantages are provided through the provision of a system for dynamically utilizing sensors to make inferences for downstream tasks. The system comprises a group of sensors of multiple modalities communicatively coupled to one or more processors; a memory; the one or more processors in communication with the memory; program instructions executable by the one or more processors to perform a method. The method can include: engaging, by the one or more processors, based on a request for an inference, from the group of sensors of the multiple modalities at a physical location, at least one sensor of a main modality to provide data to a pipeline to generate the inference, wherein the pipeline comprises one or more machine learning models, and wherein the one or more machine learning models generate the inference for a downstream task; based on the engaging of the at least one sensor of the main modality, obtaining, by the one or more processors, raw data from the at least one sensor of the main modality; applying, by the one or more processors, an outlier detector to the raw data to determine if there is an outlier in the raw data; based on determining that there is an outlier in the raw data, automatically engaging, by the one or more processors, at least one sensor of at least one different modality than the main modality from the group of sensors of multiple modalities; based on the automatically engaging of the at least one sensor of the at least one different modality, obtaining, by the one or more processors, new raw data from the at least one sensor of the at least one different modality; and applying, by the one or more processors, the one or more machine learning models to the new raw data to derive the inference.

Methods, computer program products, and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts a workflow that includes various aspects of some embodiments of the present invention;

FIG. 2 depicts a workflow that includes various aspects of some embodiments of the present invention;

FIG. 3 depicts a workflow that includes various aspects of some embodiments of the present invention;

FIG. 4 depicts a workflow and portions of a technical environment into which aspects of some embodiments of the present invention have been implemented;

FIG. 5 depicts a workflow and portions of a technical environment into which aspects of some embodiments of the present invention have been implemented;

FIG. 6 depicts a workflow that includes various aspects of some embodiments of the present invention;

FIG. 7 depicts a workflow that includes various aspects of some embodiments of the present invention;

FIG. 8 depicts on embodiment of a computing node that can be utilized in a cloud computing environment;

FIG. 9 depicts a cloud computing environment according to an embodiment of the present invention; and

FIG. 10 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

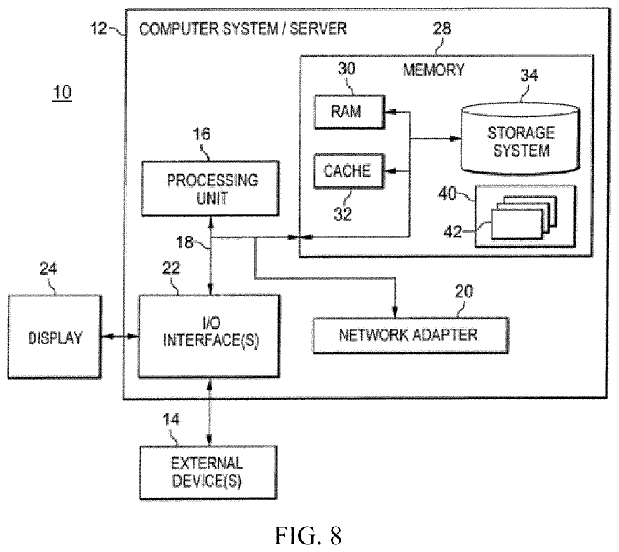

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 8 as program/utility 40, having a set (at least one) of program modules 42, may be stored in memory 28.

Embodiments of the present invention include computer-implemented methods, computer program products, and computer systems which utilize artificial intelligence (AI) to operate dynamic sensors at a given physical location to optimize the sensing data provided. This data can be utilized, for example, to inspect the given physical location. In some examples, program code executing on one or more processors obtains data from sensors of one or more modalities at the given location and analyzes the data to determine whether the quality of the data is at a pre-determined threshold (e.g., to enable the use of the data to inspect the premises at the physical location or complete the downstream task). As part of this analysis, the program code can generate a model for use in evaluating data quality (and, in some examples, the conditions under which the data was obtained that could have impacted data quality). If the program code determines that the data is below a threshold quality, the program code, in some embodiments of the present invention, can activate additional sensors at the physical location to obtain additional data from the additional sensors. The program code can then analyze this additional data to make the assessment that the original raw data was insufficient to make. The flexibility of the additional sensors in these examples can be based on the sensors being embedded in or communicatively coupled to a roaming edge device (RED). For example, if a given piece of machinery is generally inspected utilizing sensors that collect visuals but the analysis of this data indicates that no conclusion is possible within a desired level of confidence (e.g., above approximately 60%), the program code can automatically turn on a different type of sensor (e.g., temperature) and collect data utilizing these sensors, and analyze the newly collected data to generate a conclusion.

REDs can include devices with the following functionalities: 1) devices that sense their environments, including, in some cases, across multiple modalities; 2) devices that can physically move, including autonomously and/or guided by a user; and 3) devices that can execute computational workloads onboard. In some embodiments of the present invention, sensors integrated with REDs are utilized to assist in inspections of various locations, which can include, but not limited to, warehouses for various products. While performing these inspections, sensors integrated with or controlled by REDs can collect various data that can be analyzed downstream, including by AI. An advantage of utilizing sensors embedded in and/or controlled by REDs to collect data in a physical environment is that these sensors can employ multiple modalities in data gathering (multimodal sensing interfaces allow users humans to interact with systems using modes understood as five human senses: sight, smell, touch, hearing, and taste). In some embodiments of the present invention, one or more processors that analyze the various data are integrated into the REDs.

REDs can physically move, including autonomously and/or guided by a user, and thus, the portability and flexibility of these devices and the sensors associated with the devices enable the program code to determine the data needed to meet the threshold quality and to determine which of the sensors to enable to collect these data. For example, if the downstream AI in a given computer system utilized data of a given quality and quantity to determine whether a given premises is secure in advance of a weather event, based on obtaining and analyzing data collected by sensors on the premises, the program code can determine whether the quantity and/or quality of data is sufficient to make this determination. In the event that the program code cannot make this determination, the program code determines which sensors of one or more REDs of the premises could collect the data utilized in this security determination and the program code can automatically turn on identified (by the program code) sensors, such that the downstream AI analysis of the security of the premises in advance of the weather event can be completed. Thus, in embodiments of the present invention, the program code determines which sensors of an RED to utilize in a physical environment to complete a downstream AI task. The analysis can be performed by one or more processors communicatively couples to the RED and can also be integrated into the RED itself.

Embodiments of the present invention are inextricably linked to computing and have a practical application. Embodiments of the present invention couple machine leaning with REDs, with integrated multiple modality sensor capabilities, in order to optimize collection of data in various physical environments, including industrial settings, in which this collection is challenging because of one or more of the technology and/or the physical features of the environment. Both machine-learning and the REDs are inextricably linked to computing and utilizing these technologies in industrial settings where alternatives are ineffective is a practical application. Aspects of embodiments of the present invention also offer significantly more than existing approaches, some of which are discussed below, because these existing approaches are ineffective in environments with legacy systems and/or physical challenges. Thus, embodiments of the present invention solve a real-world problem regarding effectively and efficiently inspecting premises which prove challenging when utilizing existing approaches. Specifically, business operations in different industries utilize Internet of Things (IoT) devices and embed various sensors in industrial equipment, to monitor physical environments and processes performed in those environments. In these different environments, data collected by these IoT devices and sensors can be utilized, via analytics and machine learning techniques, to assist decision making, automation, and/or increasing efficiency. However, some environments do not present optimal physical conditions and/or do not include technologies that are compatible with IoT devices and embedded sensors. For example, in some environments, implementing IoT devices and sensors is too costly or not feasible (e.g., equipment is mission-critical, legacy technology). Certain physical settings include environmental detriments to implementing this type of instrumentation, such as elevated temperatures which can damage existing IoTs and sensor devices (e.g., power plants, chemical furnaces, and/or power grid stations). To address these issue/incompatibilities, examples described herein implement an approach that utilizes REDs with versatile multi-modal sensing abilities (e.g., visual, acoustic, thermal, and/or depth-sensing). As explained herein, instead of deploying a large number of sensors in legacy equipment or replacing legacy equipment, implementations of embodiments of the present invention include deploying a small number of REDs, which can navigate an environment, autonomously, and sense operational situations across these multiple modalities. As described herein, the REDs collect important operational data that can be analyzed. Additionally, the REDs are controlled via a continuously trained model, and thus, the process can be improved as it is utilized.

Embodiments of the present invention represent improvements over existing methods at least because dynamic selection of modalities for completion of AI tasks (downstream) increases the efficiency of inspections and the quality of results obtained by sensors enabled with multiple modalities. Certain existing approaches utilize multi-modal sensing and leverage the data from each mode to improve AI task performance. Various embodiments of the present invention improve upon this approach because program code in embodiments of the present invention dynamically selects a correct (custom) one or more modalities for a given AI task. Utilizing sensors with multiple modalities at all times is inefficient because most of the REDS are battery-powered and energy usage grows with usage of multiple modalities and because operational facilities have dynamic conditions, certain expected changes could incorrectly register as being problematic, as sensors are tasked with locating condition changes. When sensors in an operation environments are tasked with finding anything that is outside of expected conditions, in a dynamic environment, this task can be challenging because its performance is impacted by changes within the environment, including but not limited to, changes in lighting across day and night, changes in noise-levels at various locations in the environment, and/or movement of equipment during the operations. Although AI pipelines pipelines which provide data to AI tasks downstream) could choose inputs from multiple modalities to achieve robustness and improve performance, these AI pipelines would suffer from the variations in the environment as the noisy inputs from one or more modalities affect the accuracy. Additionally, because variations are unpredictable and unknown in advance, available training data may not cover all possible variations that are encountered at inference time. Thus, there is a need for an approach that can dynamically choose the right sensor modalities for a pre-defined AI task. As discussed below, aspects of embodiments of the present invention meet this need.

Embodiments of the present invention adapt and extend self-supervised approaches for multi-modal joint learning by combining these approaches with a general purpose out-of-distribution detection (OOD) technique. Benefits of this approach are realized, for example, in physical environments where unpredictable and unforeseen variations in sensor data are prevalent. Utilizing a machine learning model, for example, to classify conditions within a physical location as expected and/or as outliers, is challenging in physical environments where unpredictable and unforeseen variations in sensor data are prevalent. Thus, a machine learning system deployed in this environment is tasked with distinguishing between data that is anomalous or significantly different from that used in training. This is particularly important for deep neural network classifiers, which might classify OOD inputs into in-distribution classes with high confidence. Thus, determining whether inputs are OOD enables safe deployment machine learning models in the open world. Embodiments of the present invention utilize supervised, semi-supervised, and/or unsupervised deep learning through a single- or multi-layer neural networks to train the machine learning models and the outlier detector to evaluate the quality of data collected at a physical location. The program code can utilize the neural network to train and re-train machine learning algorithms, which can update these models, over time.

Embodiments of the present data provide improvements over existing AI-enabled inspection systems because in various embodiments of the present invention can dynamically adjust and obtain and analyze additional data when an environmental condition prevents a modality tasked with a certain task from providing data to complete the task within an acceptable level of confidence. In embodiments of the present invention, if a given trained model cannot provide an inference from raw data collected from a preferred modality, the program code automatically engages sensors of a different modality (all coupled to one or more REDs) to collect new raw data. The program code can then apply a different model to draw an inference from this new raw data. For example, if program code is unable to determine, within an acceptable level of confidence, that an industrial part at a factory is in working order, the program code determines which other types of sensors could gather data that would enable a conclusion for this task and automatically turns on additional sensors to collect this additional data. The program code can cease engaging different types of sensors when the program code can apply a model to the (newest) raw data to reach a conclusion within a pre-defined acceptable confidence level. In embodiments of the present invention, the new raw data, collected based on an inability to reach a conclusion analyzing the initial raw data, is analyzed to reach the conclusion. Once the program code determined that raw data cannot be utilized to produce a conclusion with an acceptable level of confidence, this data is not analyzed further.

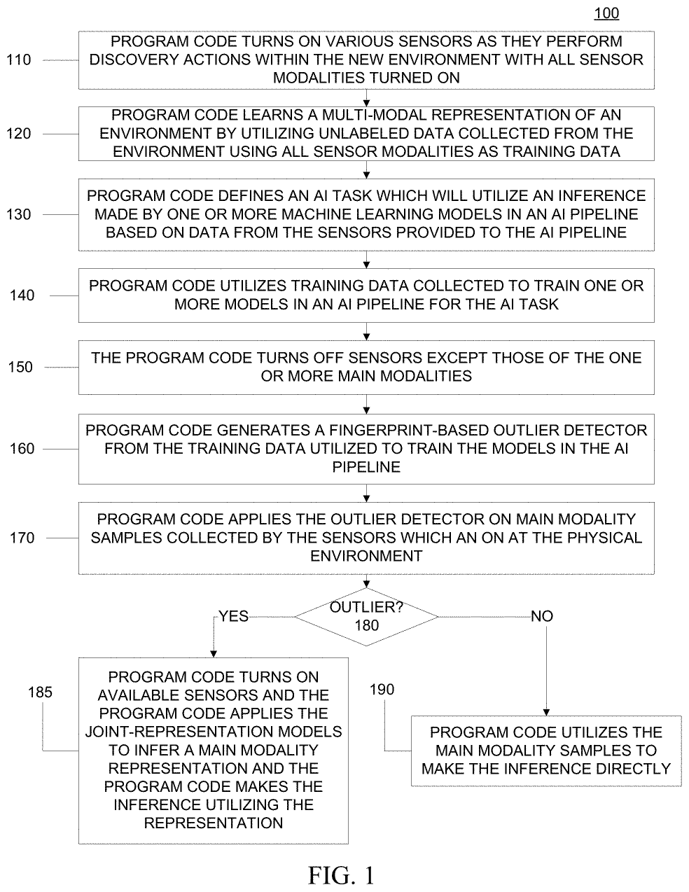

FIG. 1 is a workflow 100 that illustrates an overview of various aspects of some embodiments of the present invention. As aforementioned, in embodiments of the present invention, program code dynamically engages sensors in order to provide an AI pipeline with data to complete a given (downstream) AI task. In order to dynamically engage sensors for providing this data, the program code generates and trains a model via machine learning. Referring to FIG. 1, when a given RED is to be utilized in a new environment, the program code turns on various sensors, which can be integrated into an RED, as they perform discovery actions within the new environment with all sensor modalities turned on (110). For example, if an RED is employed, it can perform many random walks with all sensor modalities turned on to collect multi-modal, unlabeled, sensor data. The program code learns a multi-modal representation of an environment by utilizing; this unlabeled data collected from the environment using all sensor modalities as training data (120). The learning of the environment by the program code can be self-supervised.

Referring to FIG. 1, in addition to learning the environment, in embodiments of the present invention, modalities are selected based on the AI task for which the eventually collected multi-modal sensor data will be utilized. Thus, in addition to exploring a new environment to learn aspects of this environment, the program code defines an AI task which will utilize an inference made by one or more machine learning models in an AI pipeline based on data from the sensors provided to the AI pipeline (130). The program code defines the AI task based on factors including, but not limited to, main sensor modalities and features expected, the model architectures, and training and inference algorithms. The program code utilizes training data collected to train one or more models in an AI pipeline for the AI task (140). Hence, the program code trains the one or more models in the AI pipeline based on main sensor modalities (e.g., audio, optical) and determines how to derive the main modality as a function of other modalities. Once the data is collected for training purposes and the program code has determined one or more main modalities for the one or more machine learning models in the AI pipeline, the program code changes the settings of the sensors to utilize the main modality (150). The program code can turn off all the sensors except those of the one or more main modalities. For example, the program code can determine which modalities to prioritize for different model. In the case where inspecting a given physical object includes determining the temperature of the object to see whether the temperature is within an expected range, the program code can prioritize infrared sensors.

For each machine learning model utilized to train the AI pipeline, the program code generates a fingerprint-based outlier detector from the training data utilized to train the models in the AI pipeline (160). An outlier detector determines whether a given model input is beyond what the model was “taught” during training. An 001D technique is used to determine whether a sample in the main modality is of poor quality because the outlier detector produces a “distance” between an input sample and the distribution of samples in the training set. The combined use of the trained models in the pipeline and the outlier detector for each model, enables the program code to utilize the models (in a self-supervised manner) to learn joint representation from the raw unlabeled multi-modal data such that the program code can infer main modality representation given the rest of the modalities. In contrast to some existing systems, inferring main modality representation given one or more of the remaining modalities does not mean taking the data collected by a given modality, which the program code determined is an outlier, and analyzing this data, differently. Rather, in embodiments of the present invention, once the program code determines that this data is an outlier, the program code automatically selects another modality and collects new raw data from the physical space to analyze to make a determination (e.g., inference).

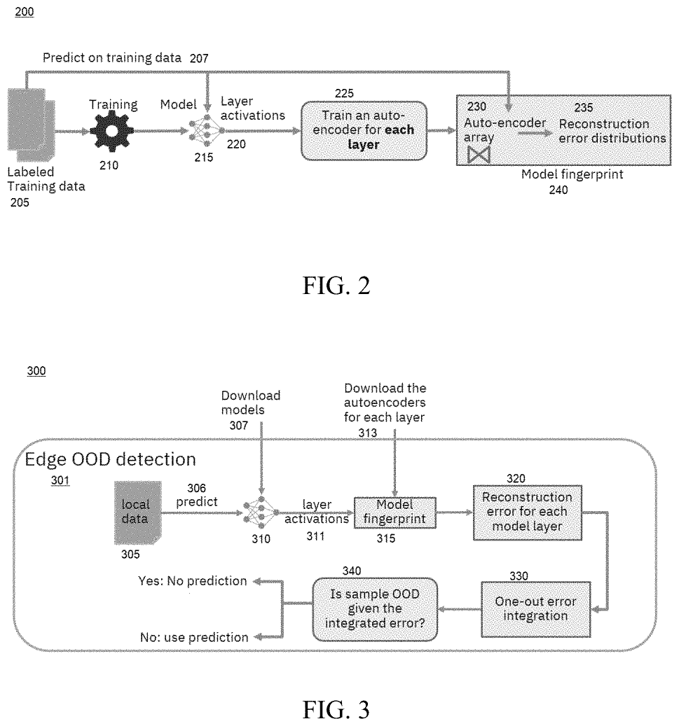

FIGS. 2-3 illustrate the training of an outlier detector in accordance with various aspects of the present invention. To train the outlier detector, the program code generates model fingerprints as this is a fingerprint-based outlier detector. This process is depicted in FIG. 2. The program code then determines the likelihood of a model input being OOD given the reconstruction error distributions during training. This aspect is depicted in FIG. 3.

Referring first to FIG. 2, in the depicted example 200, the program code utilizes labeled training data 205 (in this example, the training data utilized to train the model from the multi-modal data collection at the physical location) to train a model 210. The program code trains an auto-encoder for each layer 225 of the model 210, to generate an auto-encoder array 230. An auto-encoder is a type of neural network that can be used to learn a compressed representation of raw data; it is composed of an encoder and a decoder sub-models. The encoder can be used as a data preparation technique to perform feature extraction on raw data that can be used to train different machine learning models. The program code utilizes the auto-encoder array 230 to determine reconstruction error distribution 235. The auto-encoder array 230 and the reconstruction error distribution 235 comprise a model fingerprint 240. As the model is continuously updated via self-supervised machine-learning, the program code can additionally predict training data 207, and utilize the predicted training data 207 to train the model 215 and generate the auto-encoder array 230.

FIG. 3 depicts the program code determining a likelihood of a model input being OOD given the reconstruction error distributions during training. As illustrated in FIG. 3, the program code performs OOD edge detection 301 by obtaining local data 305 and utilizing that data to make a prediction 310 with a (e.g., downloaded 307) model 310. The program code activates the layers 311 and downloads the autoencoders for each layer 313 to obtain the model fingerprint 315. From the fingerprint 315, the program code reconstructs errors for each model layer 320 and performs a one-out error integration 330 to determine if the sample OOD given the integrated error 340. If the program code determines that the sample OOD includes an integrated error, no prediction can be made (in some cases, deference can be made to a human expert to substitute judgment). If the program code determines that the sample OOD is not given the integrated error, the prediction can be utilized.

Returning to FIG. 1, the program code determines whether an inference utilized by the AI task can be made with the collected main modality data. To determine whether an inference can be made the program code applies the outlier detector on main modality samples collected by the sensors which an on at the physical environment (170). The program code can make an inference based on a main modality representation. This representation can either be provided based on the sensor data collected by the main modality sensors (e.g., audio, video) or can be inferred from data from additional sensors if the data provided by the main modality sensors (which are the only sensors that are engaged automatically) are of poor quality (as determined by the outlier detector). The inferred representation is a self-supervised joint representation that the program code utilizes to infer a representation of the main modalities based on the samples of the rest of the modalities.

The program code determines if the main modality samples include an outlier (180). If the program code determines that data includes one or more outliers, the program code turns on available sensors and the program code applies the joint-representation models to infer a main modality representation of the main modalities based on the samples of the rest of the modalities and the program code makes the inference utilizing the representation (185). In some embodiments of the present invention, the program code can determine that certain specific modality data can be used to supplement the main modality data. In this case, the program code can engage only those sensors of this certain specific modality rather than all the additional sensors. If the program code determines that there is no outlier, the program code utilizes the main modality samples to make the inference directly (190). By including the flexibility of utilizing either a main modality representation from main modality sensor data or an inferred main modality representation, embodiments of the present invention are robust in that any issues with main modality data (e.g., environmental challenges) are dynamically supplemented by other modalities. When the program code engages additional sensors, the program code triggers these sensors to collect new raw data and the program code analyzes this new raw data to make the determination that could not be made from the earlier data (if this new data is an outlier, steps of the workflow can repeat until suitable raw data is available from which the program code can make an inference).

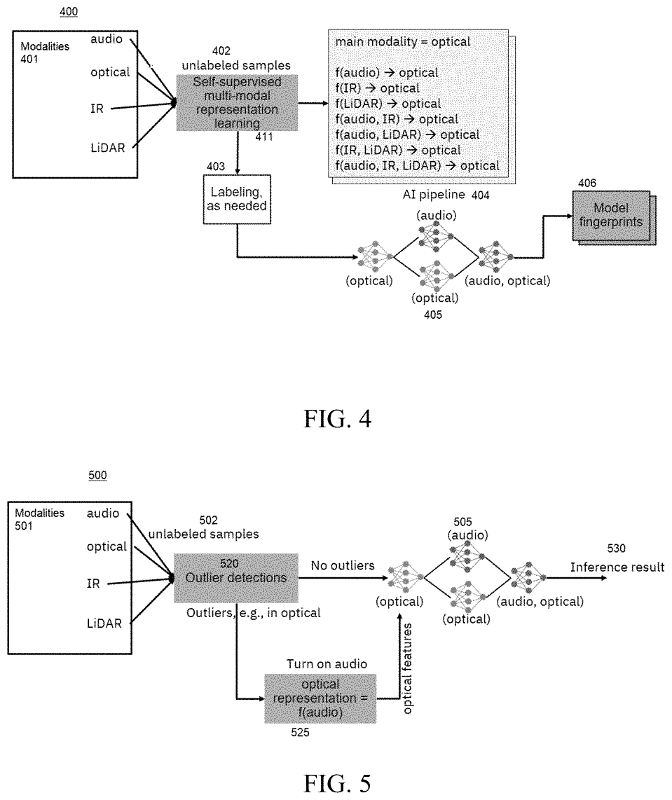

FIGS. 4-5 provide illustrations of aspects of the examples herein, including depictions of various aspects of a technical environment into which various aspects of embodiments of the present invention are integrated. FIGS. 4-5 review various aspects of the workflow 100 of FIG. 1, including but not limited to utilizing self-supervised multi-modal learning and outlier detection to detect noisy modalities and recover samples from joint representations.

FIG. 4 depicts a process and structural aspects of a system 400 that include the program code training a model for an AI pipeline and generating an outlier detector. In this example, one or more REDs in a physical environment controls and/or is integrated with sensors for a number of different modalities. The sensors include audio, optical, infrared (IR), and light detecting and ranging (lidar) sensors. The program code determines the main modalities which can be utilized in a physical space. The sensors collect unlabeled sample data 402 for self-supervised multi-modal representation learning 411. In this example, the program code determines, through supervised multi-modal representation learning 411, that the main modality for this physical space (in this non-limiting example) is optical. FIG. 4 illustrates how a representation of the main modality can either be optical data (from the optical sensor) or a combination of the sensor data from the various other modalities. The program code determines a combination of sensor data which can be substituted for a main modality in the physical space if raw data collected by the main modality data is not useable. The program code labels 403 the unlabeled samples 402 as needed such that the models in the AI pipeline 404 can be trained. In this example, the program code learns a multi-modal representation of an environment 411 by utilizing this unlabeled data 402 collected from the environment using all sensor modalities 401 as training data.

The program code defines an AI task which is to be completed utilizing data from RED device sensors. The program code defines the AI task based on factors including, but not limited to, main sensor modalities and features expected, the model architectures, and training and inference algorithms and utilizes the training data collected for the AI task to train one or more models 405 in an AI pipeline 404. As illustrated in FIG. 4, the program code determines how each sensor can be utilized to collect raw data that can be substituted for the data from the main modality if the data from the main modality is unavailable or unusable. As illustrated in FIG. 4, the sensors/modalities 401 include audio, optical, IR, and lidar. Thus, because the main modality, to be utilized by at least one or more machine learning models 405 in the AI pipeline 404 utilizes optical sensor data (i.e., the main modality), the program code determines how it can utilize each modality type to collect data from which to derive the inferences desired from the main modality data, should the actual raw data from the main modality be unusable. Thus, the program code can make a given inference from optical data as a function of audio, IR, lidar, audio and IR, audio and lidar, IR and lidar, and a combination of all of audio, IR, and lidar. As will be illustrated in FIG. 5, should the program code (applying an outlier detector) determine that the raw optical data to be utilized to make an inference is an outlier, the program code can determine which sensors to engage to obtain new data to analyze to make this inference. Thus, the program code determines pair-wise joint-representations for each main modality. In this case, as is demonstrated in FIG. 5, engaging the audio sensor could be the easiest approach to obtaining additional data to utilize in providing the inference.

Returning to FIG. 4, the program code trains the one or more models 405 in the AI pipeline 404 based on main sensor modalities (e.g., audio, optical). As examples, various models 405 in the AI pipeline 404 utilize as data in making determinations optical data, audio data, and/or a combination of these modalities (i.e., main modalities). The program code generates a model fingerprint 406 (see, FIG. 2), which is utilized by an outlier detector generated by the program code.

FIG. 5 illustrates usage of the outlier detector and the trained models of the AI pipeline in various embodiments of the present invention. FIG. 5 demonstrates the utilization of the outlier detector and trained models in the AI pipeline from FIG. 4. Thus, the resultant inference 530 of FIG. 5 is provided to the AI task, downstream. Specifically, the program code illustrates the program code, applying the outlier detector and the trained models to make an inference which can be utilized by an AI take downstream. FIG. 5 depicts aspects of a process and system 500 for making this inference. As aforementioned, the sensors with multiple modalities 501, are controlled by and/or integrated into one or more REDs, which have been deployed in a physical space. Certain of the sensors, which were turned on, provide the main modality (e.g., optical) for the AI task. The program code obtains unlabeled samples 502 from the sensors. The program code performs OOD detection 520 by applying the outlier detector to the samples 502. If the program code determines that there are no outliers in the samples 502 the program code provides the samples 502 to the model (no outliers indicates that the program code has determined that the main modality, in this case, optical, is sufficiently present, in the sample 502 for the model to produce an inference result 530 for the AI task). If the program code determines that there are outliers in the samples 502, meaning that the optical data is not of a quality that can be utilized by the models 505 in the AI pipeline to produce an inference result 530, the program code dynamically turns on sensors to obtain data from a different modality, from which the program code can make the inference that could not be made from data from the main modality. In this example, the program code engages audio sensing 525 and generates what can be understood as a representation of the optical data from the audio. The program code applies the models 505 in the AI pipeline to the optical features, which can be a combination of collected optical data and derived optical data (from the audio). The program code obtains an inference result 530 from the models 505 based on providing the models 505 with the representation of the main modality data, rather than the actual main modality data. Thus, by dynamically turning on audio sensing in at the physical location, program code executing on one or more processors can generate an inference result 530 for use by an AI task despite the data generally utilized in the AI pipeline being of poor quality.

Embodiments of the present invention provide significant advantages over existing methods of utilizing multi-modal sensing for improving AI task performance. Existing approaches leverage multiple sensors to improve AI task performance and the modalities being used are fixed. This approach is expensive and not always possible in certain industrial environments with legacy systems and/or challenging environmental conditions (e.g., high temperatures, low light). In contrast, by utilizing REDs, which can be mobile, to provide sensing data, the examples herein enable dynamic decisions when given modalities are noisy. Embodiments of the present invention enable program code executing on one or more processors to automatically select a main modality for a given AI task and to provide additional or alternate data from additional modalities when the quality of the data for the main modality is compromised (e.g., noisy). For example, the program code can determine, based of the REDs and sensors exploring a given location, that a given AI task may utilize optical data from this location to determine whether there is an issue with equipment at the location. The program code can then evaluate the quality of the optical data obtained from the sensors and determine whether additional data from a different modality is needed for the given AI task. Thus, unlike existing approaches, some embodiments of the present invention: 1) utilize self-supervised learning between multiple modalities; 2) apply joint representation learning among audio and visual modalities; 3) detect noisy modalities; and/or 4) use representations of other modalities to recover the noisy modality.

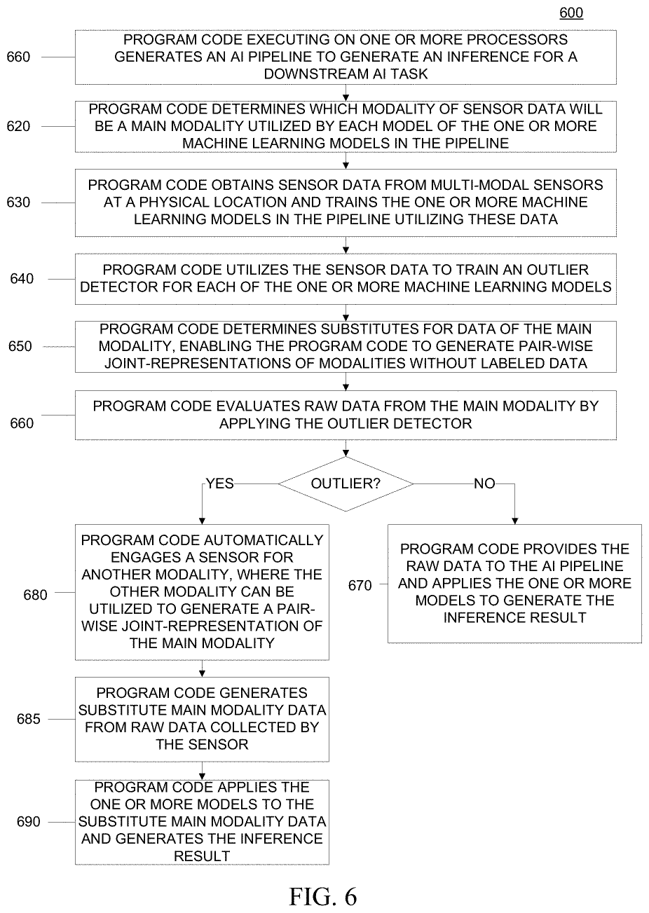

FIG. 6 is a workflow 600 that illustrates certain aspects of some embodiments of the present invention. In some embodiments of the present invention, program code executing on one or more processors generates an AI pipeline to generate an inference for a downstream AI task (610). The AI pipeline can include one or more machine learning models because the program code generated the AI pipeline to accomplish a specific machine learning task consisting of these one or more machine learning models. The program code determines which modality of sensor data will be a main modality utilized by each model of the one or more machine learning models in the pipeline (620). The program code obtains sensor data from multi-modal sensors at a physical location and trains the one or more machine learning models in the pipeline utilizing these data (630). The program code utilizes the sensor data to train an outlier detector for each of the one or more machine learning models (640). The program code determines, through self-supervised learning, for the machine learning models in the AI pipeline, how each modality that is not the main modality, alone or together with one or more other modalities can be utilized to produce data which can be substituted for data of the main modality, thus enabling the program code to generate pair-wise joint-representations of modalities without labeled data (650). Based on the program code obtaining a request for the program code to generate an inference (to be utilized by the AI task), the program code evaluates raw data from the main modality by applying the outlier detector (660). Based on not detecting an outlier, the program code provides the raw data to the AI pipeline and applies the one or more models to generate the inference result (670). Based on detecting an outlier, the program code automatically engages a sensor for another modality, where the other modality can be utilized to generate a pair-wise joint-representation of the main modality (680). The program code generates substitute main modality data from raw data collected by the sensor (685). The program code applies the one or more models to the substitute main modality data and generates the inference result (690). Thus, the program code can either generate the inference result directly based on data from the main modality or by utilizing a representation of the main modality (which is newly collected raw data from the newly engaged sensor).

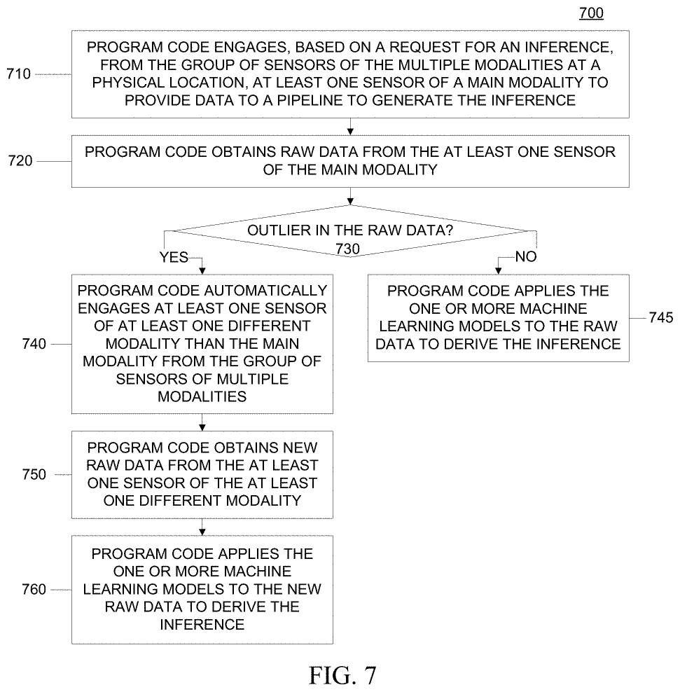

FIG. 7 is a workflow 700 that illustrates various aspects of some embodiments of the present invention. In this example, program code executing on one or more processors engages, based on a request for an inference, from the group of sensors of the multiple modalities at a physical location, at least one sensor of a main modality to provide data to a pipeline to generate the inference (710). The pipeline includes one or more machine learning models. These machine learning models generate the inference for a downstream task. The program code obtains raw data from the at least one sensor of the main modality (720). The program code applies an outlier detector to the raw data to determine if there is an outlier in the raw data (730). Based on determining that there is an outlier in the raw data, the program code automatically engages at least one sensor of at least one different modality than the main modality from the group of sensors of multiple modalities (740). The program code obtains new raw data from the at least one sensor of the at least one different modality (750). The program code applies the one or more machine learning models to the new raw data to derive the inference (760). Meanwhile, based on determining that there is no outlier in the raw data, the program code applies the one or more machine learning models to the raw data to derive the inference (745).

Embodiments of the present invention include methods, computer program products, and systems that dynamically engage sensors for various tasks. In some examples, the method can include program code executing on one or more processors engaging, based on a request for an inference, from a group of sensors of multiple modalities at a physical location, at least one sensor of a main modality to provide data to a pipeline to generate the inference, where the pipeline comprises one or more machine learning models, and where the one or more machine learning models generate the inference for a downstream task. Based on the engaging of the at least one sensor of the main modality, the program code obtains raw data from the at least one sensor of the main modality. The program code applies an outlier detector to the raw data to determine if there is an outlier in the raw data. Based on determining that there is an outlier in the raw data, the program code automatically engages at least one sensor of at least one different modality than the main modality from the group of sensors of multiple modalities. Based on the engaging of the at least one sensor of the at least one different modality, the program code obtains new raw data from the at least one sensor of the at least one different modality. The program code applies the one or more machine learning models to the new raw data to derive the inference.

In some examples, based on determining that there is no outlier in the raw data, the program code applies the one or more machine learning models to the raw data to derive the inference.

In some examples, the program code determines the main modality of multiple modalities for sensor data provided to the pipeline to generate the inference. The program code obtains data from the group of sensors of the multiple modalities. The program code utilizes the data from the group of sensors to train the one or more machine learning models, based on the physical location. The program code generates an outlier detector for each of the one or more machine learning models, based on the data from the group of sensors.

In some examples, the program code generates the pipeline.

In some examples, the raw data comprises unlabeled data.

In some examples, the pipeline is an artificial intelligence pipeline and the task is an artificial intelligence task.

In some examples, the group of sensors of the multiple modalities are integrated into a roaming edge device.

In some examples, the program code determines, based on the one or more machine learning models and the main modality, one or more modalities which provide data to generate the inference for a downstream task in addition to the main modality data, where the at least one sensor of the at least one different modality than the main modality comprises the one or more modalities.

In some examples, the main modality comprises one or more of: optical, audio, infrared, or light detecting and ranging.

In some examples, the main modality is selected from the group consisting of: optical, audio, infrared, and light detecting and ranging.

In some examples, the at least one sensor of at least one different modality than the main modality comprises all available sensors at the location.

Some embodiments of the present invention include a computer program product that includes a computer readable storage medium readable by one or more processors of a shared computing environment comprising a computing system and storing instructions for execution by the one or more processors for performing a method. The method can include program code executing on one or more processors engaging, based on a request for an inference, from a group of sensors of multiple modalities at a physical location, at least one sensor of a main modality to provide data to a pipeline to generate the inference, where the pipeline comprises one or more machine learning models, and where the one or more machine learning models generate the inference for a downstream task. Based on the engaging of the at least one sensor of the main modality, the program code obtains raw data from the at least one sensor of the main modality. The program code applies an outlier detector to the raw data to determine if there is an outlier in the raw data. Based on determining that there is an outlier in the raw data, the program code automatically engages at least one sensor of at least one different modality than the main modality from the group of sensors of multiple modalities. Based on the engaging of the at least one sensor of the at least one different modality, the program code obtains new raw data from the at least one sensor of the at least one different modality. The program code applies the one or more machine learning models to the new raw data to derive the inference.

In some examples, based on determining that there is no outlier in the raw data, the program code applies the one or more machine learning models to the raw data to derive the inference.

In some examples, the program code determines the main modality of multiple modalities for sensor data provided to the pipeline to generate the inference. The program code obtains data from the group of sensors of the multiple modalities. The program code utilizes the data from the group of sensors to train the one or more machine learning models, based on the physical location. The program code generates an outlier detector for each of the one or more machine learning models, based on the data from the group of sensors.

In some examples, the program code generates the pipeline.

In some examples, the raw data comprises unlabeled data.

In some examples, the pipeline is an artificial intelligence pipeline and the task is an artificial intelligence task.

In some examples, the group of sensors of the multiple modalities are integrated into a roaming edge device.

In some examples, the program code determines, based on the one or more machine learning models and the main modality, one or more modalities which provide data to generate the inference for a downstream task in addition to the main modality data, where the at least one sensor of the at least one different modality than the main modality comprises the one or more modalities.

In some examples, the main modality comprises one or more of: optical, audio, infrared, or light detecting and ranging.

In some examples, the main modality is selected from the group consisting of: optical, audio, infrared, and light detecting and ranging.

In some examples, the at least one sensor of at least one different modality than the main modality comprises all available sensors at the location.

Some embodiments of the present invention include a computer system which comprises: a group of sensors of multiple modalities communicatively coupled to one or more processors, a memory, the one or more processors in communication with the memory, and program instructions executable by the one or more processors to perform a method. The method can include program code executing on one or more processors engaging, based on a request for an inference, from a group of sensors of multiple modalities at a physical location, at least one sensor of a main modality to provide data to a pipeline to generate the inference, where the pipeline comprises one or more machine learning models, and where the one or more machine learning models generate the inference for a downstream task. Based on the engaging of the at least one sensor of the main modality, the program code obtains raw data from the at least one sensor of the main modality. The program code applies an outlier detector to the raw data to determine if there is an outlier in the raw data. Based on determining that there is an outlier in the raw data, the program code automatically engages at least one sensor of at least one different modality than the main modality from the group of sensors of multiple modalities. Based on the engaging of the at least one sensor of the at least one different modality, the program code obtains new raw data from the at least one sensor of the at least one different modality. The program code applies the one or more machine learning models to the new raw data to derive the inference.

In some examples, based on determining that there is no outlier in the raw data, the program code applies the one or more machine learning models to the raw data to derive the inference.

In some examples, the program code determines the main modality of multiple modalities for sensor data provided to the pipeline to generate the inference. The program code obtains data from the group of sensors of the multiple modalities. The program code utilizes the data from the group of sensors to train the one or more machine learning models, based on the physical location. The program code generates an outlier detector for each of the one or more machine learning models, based on the data from the group of sensors.

In some examples, the program code generates the pipeline.

In some examples, the raw data comprises unlabeled data.

In some examples, the pipeline is an artificial intelligence pipeline and the task is an artificial intelligence task.

In some examples, the group of sensors of the multiple modalities are integrated into a roaming edge device.

In some examples, the program code determines, based on the one or more machine learning models and the main modality, one or more modalities which provide data to generate the inference for a downstream task in addition to the main modality data, where the at least one sensor of the at least one different modality than the main modality comprises the one or more modalities.

In some examples, the main modality comprises one or more of: optical, audio, infrared, or light detecting and ranging.

In some examples, the main modality is selected from the group consisting of: optical, audio, infrared, and light detecting and ranging.

In some examples, the at least one sensor of at least one different modality than the main modality comprises all available sensors at the location.

Referring now to FIG. 8, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the one or more of the technical environment, including but not limited to, the REDs and any processors that are not part of the RED that are communicatively coupled to the REDs and/or the sensors described herein, can each comprise a cloud computing node 10 (FIG. 8) and if not a cloud computing node 10, then one or more general computing nodes that include aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired aF1pplications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

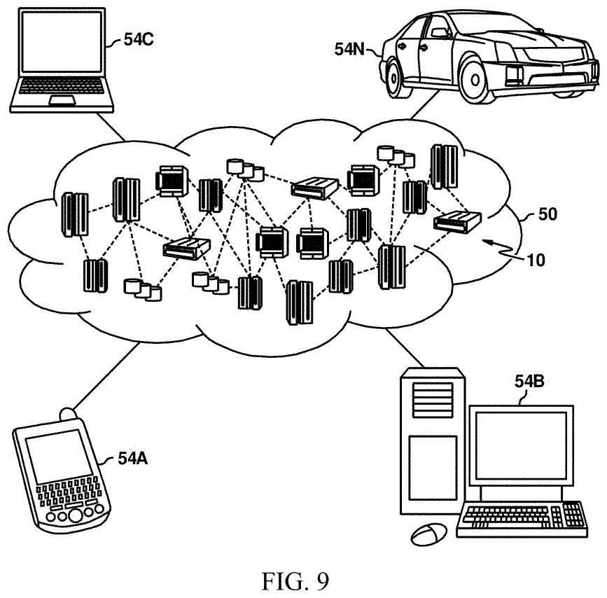

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

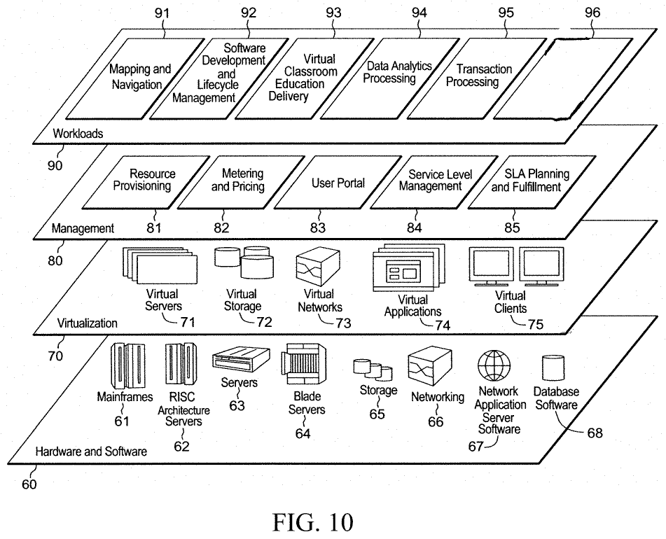

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. Workloads can also include virtual examination centers or online examinations (not pictured).

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generating an inference result based on multi-modal sensor data 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
engaging, by one or more processors, based on a request for an inference, from a group of sensors of multiple modalities at a physical location, at least one sensor of a main modality to provide data to a pipeline to generate the inference, wherein the pipeline comprises one or more machine learning models, and wherein the one or more machine learning models generate the inference for a downstream task;
based on the engaging of the at least one sensor of the main modality, obtaining, by the one or more processors, raw data from the at least one sensor of the main modality;
applying, by the one or more processors, an outlier detector to the raw data to determine if there is an outlier in the raw data;
based on determining that there is an outlier in the raw data, automatically engaging, by the one or more processors, at least one sensor of at least one different modality than the main modality from the group of sensors of multiple modalities;
based on the automatically engaging of the at least one sensor of the at least one different modality, obtaining, by the one or more processors, new raw data from the at least one sensor of the at least one different modality; and
applying, by the one or more processors, the one or more machine learning models to the new raw data to derive the inference.

2. The computer-implemented method of claim 1, further comprising:
based on determining that there is no outlier in the raw data, applying, by the one or more processors, the one or more machine learning models to the raw data to derive the inference.

3. The computer-implemented method of claim 1, further comprising:
determining, by the one or more processors, the main modality of multiple modalities for sensor data provided to the pipeline to generate the inference;
obtaining, by the one or more processors, data from the group of sensors of the multiple modalities;
utilizing, by the one or more processors, the data from the group of sensors to train the one or more machine learning models, based on the physical location; and
generating, by the one or more processors, an outlier detector for each of the one or more machine learning models, based on the data from the group of sensors.

4. The computer-implemented method of claim 1, further comprising:
generating, by one or more processors, the pipeline.

5. The computer-implemented method of claim 1, wherein the raw data comprises unlabeled data.

6. The computer-implemented method of claim 1, wherein the pipeline is an artificial intelligence pipeline and the task is an artificial intelligence task.

7. The computer-implemented method of claim 1, wherein the group of sensors of the multiple modalities are integrated into a roaming edge device.

8. The computer-implemented method of claim 1, further comprising:
determining, by the one or more processors, based on the one or more machine learning models and the main modality, one or more modalities which provide data to generate the inference for a downstream task in addition to the main modality data, wherein the at least one sensor of the at least one different modality than the main modality comprises the one or more modalities.

9. The computer-implemented method of claim 1, wherein the main modality is selected from the group consisting of: optical, audio, infrared, and light detecting and ranging.

10. The computer-implemented method of claim 1, wherein the at least one sensor of at least one different modality than the main modality comprises all available sensors at the location.

11. A computer program product comprising:
a computer readable storage medium readable by one or more processors of a shared computing environment comprising a computing system and storing instructions for execution by the one or more processors for performing a method comprising:
engaging, by the one or more processors, based on a request for an inference, from a group of sensors of multiple modalities at a physical location, at least one sensor of a main modality to provide data to a pipeline to generate the inference, wherein the pipeline comprises one or more machine learning models, and wherein the one or more machine learning models generate the inference for a downstream task;
based on the engaging of the at least one sensor of the main modality, obtaining, by the one or more processors, raw data from the at least one sensor of the main modality;
applying, by the one or more processors, an outlier detector to the raw data to determine if there is an outlier in the raw data;
based on determining that there is an outlier in the raw data, automatically engaging, by the one or more processors, at least one sensor of at least one different modality than the main modality from the group of sensors of multiple modalities;
based on the automatically engaging of the at least one sensor of the at least one different modality, obtaining, by the one or more processors, new raw data from the at least one sensor of the at least one different modality; and
applying, by the one or more processors, the one or more machine learning models to the new raw data to derive the inference.

12. The computer program product of claim 11, further comprising:
based on determining that there is no outlier in the raw data, applying, by the one or more processors, the one or more machine learning models to the raw data to derive the inference.

13. The computer program product of claim 11, further comprising:
determining, by the one or more processors, the main modality of multiple modalities for sensor data provided to the pipeline to generate the inference;
obtaining, by the one or more processors, data from the group of sensors of the multiple modalities;
utilizing, by the one or more processors, the data from the group of sensors to train the one or more machine learning models, based on the physical location; and
generating, by the one or more processors, an outlier detector for each of the one or more machine learning models, based on the data from the group of sensors.

14. The computer program product of claim 11, further comprising:
generating, by one or more processors, the pipeline.

15. The computer program product of claim 11, wherein the raw data comprises unlabeled data.

16. The computer program product of claim 11, wherein the pipeline is an artificial intelligence pipeline and the task is an artificial intelligence task.

17. A computer system comprising:
a group of sensors of multiple modalities communicatively coupled to one or more processors;
a memory;
the one or more processors in communication with the memory;
program instructions executable by the one or more processors to perform a method, the method comprising:
based on the engaging of the at least one sensor of the main modality, obtaining, by the
one or more processors, raw data from the at least one sensor of the main modality;
applying, by the one or more processors, an outlier detector to the raw data to determine if there is an outlier in the raw data;
based on determining that there is an outlier in the raw data, automatically engaging, by the one or more processors, at least one sensor of at least one different modality than the main modality from the group of sensors of multiple modalities;
based on the automatically engaging of the at least one sensor of the at least one different modality, obtaining, by the one or more processors, new raw data from the at least one sensor of the at least one different modality; and
applying, by the one or more processors, the one or more machine learning models to the new raw data to derive the inference.

18. The system of claim 17, the method further comprising:
based on determining that there is no outlier in the raw data, applying, by the one or more processors, the one or more machine learning models to the raw data to derive the inference.

19. The system of claim 17, the method further comprising:
determining, by the one or more processors, the main modality of multiple modalities for sensor data provided to the pipeline to generate the inference;
obtaining, by the one or more processors, data from the group of sensors of the multiple modalities;
utilizing, by the one or more processors, the data from the group of sensors to train the one or more machine learning models, based on the physical location; and
generating, by the one or more processors, an outlier detector for each of the one or more machine learning models, based on the data from the group of sensors.

20. The system of claim 17, wherein a roaming edge device comprises the group of sensors of the multiple modalities communicatively and the one or more processors.
